(19) United States
(12) Patent Application Publication
(10) Pub. No.: US 2026/0322561 A1
(43) Pub. Date: Oct. 15, 2026

(54) SYSTEMS, METHODS, AND APPARATUSES FOR UNIFIED TRANSMISSION CONFIGURATION INDICATOR STATE INDICATION FOR MULTI-DOWNLINK CONTROL INFORMATION MULTI-TRANSMISSION RECEPTION POINT USE CASES IN WIRELESS COMMUNICATION

(71) Applicant: APPLE INC., Cupertino, CA (US)

(72) Inventors: Hong He, San Jose, CA (US); Dawei Zhang, Saratoga, CA (US); Wei Zeng, San Diego, CA (US); Oghenekome Oteri, San Diego, CA (US); Haitong Sun, Cupertino, CA (US); Chunxuan Ye, San Diego, CA (US); Sigen Ye, San Diego, CA (US); Weidong Yang, San Diego, CA (US); Seyed Ali Akbar Fakoorian, San Diego, CA (US); Jie Cui, San Jose, CA (US)

(21) Appl. No.: 19/101,373

(22) PCT Filed: Jan. 24, 2023
(86) PCT No.: PCT/US2023/061135

§ 371 Date: Feb. 5, 2025

Related U.S. Application Data
(60) Provisional application No. 63/370,980, filed on Aug. 10, 2022.

(51) Int. Cl. H04L 5/00; H04W 72/232

(52) U.S. Cl. CPC H04L 5/0053; H04W 72/232

(57) ABSTRACT

Systems, methods, and apparatuses for unified transmission configuration indicator (TCI) state indication for multi-downlink control information (mDCI) multi-transmission reception point (mTRP) use cases are discussed. Manners of making TCI state indications for mDCI mTRP that use TCI state lists, medium access control control elements (MAC-CEs), and/or downlink control information (DCI) are discussed. Determinations of TCI state(s) at a user equipment (UE) for physical downlink control channel (PDCCH) reception and/or physical downlink shared channel (PDSCH) reception are discussed. Applications of a unified TCI state for other types of downlink (DL) and/or uplink (UL) channels are also discussed.

### TECHNICAL FIELD

This application relates generally to wireless communication systems, including wireless communication systems using methods of TCI State indication.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mm Wave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram showing a use of more than two UL/UL TCI States to extend a unified TCI framework for mTRP, according to an embodiment.

FIG. 2A illustrates a first state list set and a second state list set that are differentiated by their uses of a CORESETPoolIndex.

FIG. 2B illustrates a MAC-CE for the activation of DL or UL TCI states for a CORESETPoolIndex.

FIG. 3 illustrates a diagram showing the use of a single 3-bit TCI field to indicate the unified TCI state pairs for two TRPs.

FIG. 4 illustrates a diagram showing uses of two TCI fields in DCI format 1_1/1_2.

FIG. 5 illustrates a DCI format showing a TRP-ID field of a DCI format that indicates a TRP ID for which the TCI field information is applied.

FIG. 6 provides examples in accordance with two alternatives for PDSCH reception within a default QCL window.

FIG. 7 illustrates a method of a RAN, according to embodiments herein.

FIG. 8 illustrates a method of a UE, according to embodiments herein.

FIG. 9 illustrates a method of a UE, according to embodiments herein.

FIG. 10 illustrates a method of a UE, according to embodiments herein.

FIG. 11 illustrates a method of a UE, according to embodiments herein.

FIG. 12 illustrates a method of a UE, according to embodiments herein.

FIG. 13 illustrates an example architecture of a wireless communication system, according to embodiments disclosed herein.

FIG. 14 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

A few years after the first deployment of NR, it is becoming clear that the transmission configuration indicator (TCI) state framework in Release-15 was unnecessarily flexible, which lead to a significant signaling overhead. A unified TCI framework was introduced in Release-17 which facilitates streamlined multi-beam operation targeting FR2. As Release-17 focuses on single-transmission reception point (TRP) (sTRP) use cases, the extension of a unified TCI framework that focuses on multiple-TRP (mTRP) use cases is beneficial.

A multiple input multiple output (MIMO) evolution for downlink (DL) and uplink (UL) that enhances the Release-17 unified TCI framework is called for. Such enhancements to the Release-17 unified TCI framework for mTRP use cases may specify for indications of multiple DL and UL TCI states focusing on the mTRP use cases.

The Release-17 TCI framework provides optimized support for the case where all UL and DL signals/channels are received/transmitted using the same beam, or TCI. It also provides optimized support for the case where all DL signals are received in one beam, and all UL signals are transmitted in one beam. Within these aspects of a Release-17 unified TCI framework, it may not be possible to support mTRP reception.

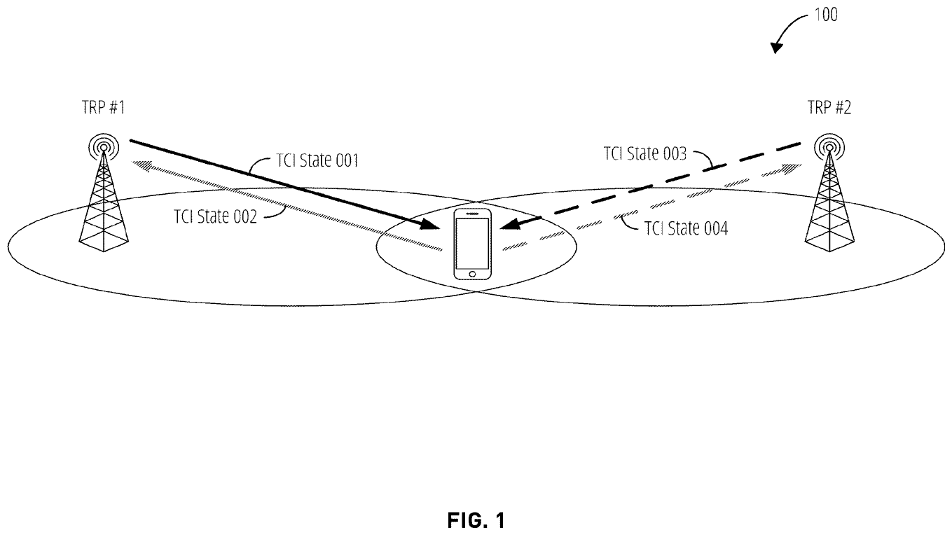

FIG. 1 illustrates a diagram 100 showing a use of more than two UL/UL TCI States to extend a unified TCI framework for mTRP, according to an embodiment.

Potential issues for a unified TCI framework extension for multiple-downlink control information (mDCI) mTRP use case are 1) how to provide UE with multiple TCI States associated with mTRPs (e.g., four TCI States 001/002/003/004 with TRP #1 and TRP #2 respectively, as illustrated in FIGS. 1), and 2) how to select the multiple DL or UL TCI State for different DL/UL channel reception/transmission, with consideration for both a time before the timeDurationForQCL starting from the symbol of DL downlink control information (DCI) and a time after it.

According to certain aspects of this disclosure, a variety of approaches maybe considered for unified TCI State indication for an mDCI mTRP use case.

First, a UE may be configured with up to four TCI State lists as follows: a first DL TCI State list and a first UL TCI State list for a first TRP, and a second DL TCI State list and a second UL TCI State list for a first TRP. A control resource set (CORESET) pool index (CORESETPoolIndex) value ‘0’ or ‘1’ maybe assigned for each DL TCI State list and UL TCI State list.

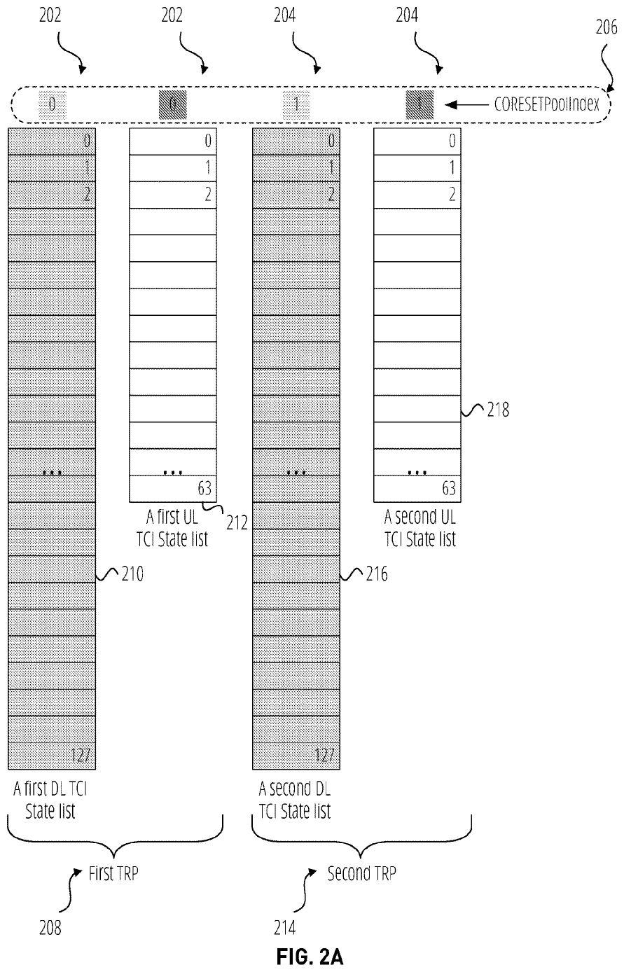

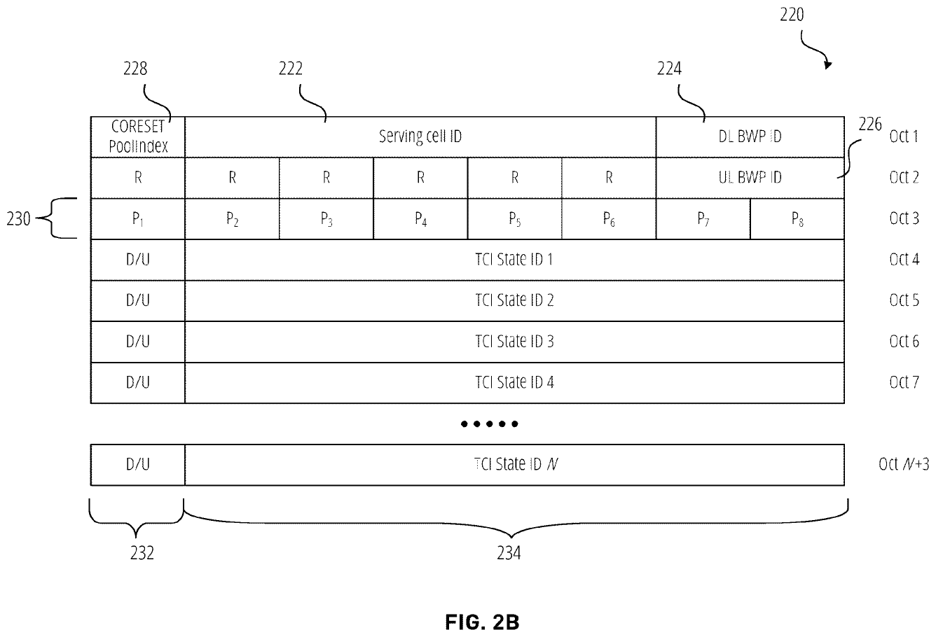

FIG. 2A illustrates a first TCI State list set 202 and a second TCI State list set 204 that are differentiated by their corresponding CORESETPoolIndex 206. The first TCI State list set 202 may be for a first TRP 208 and include a first DL TCI State list 210 and a first UL TCI State list 212. As illustrated, the first DL TCI State list 210 and the first UL TCI State list 212 correspond to the use of a value ‘0’ as the applicable CORESETPoolIndex 206.

The second TCI State list set 204 may be for a second TRP 214 and include a second DL TCI State list 216 and a second UL TCI State list 218. As illustrated, the second DL TCI State list 216 and the second UL TCI State list 218 correspond to the use of a value ‘1’ as the applicable CORESETPoolIndex 206.

Then, once the UE is configured with the up to four TCI State lists, a new medium access control control element (MAC-CE) may be introduced to activate DL or UL TCI States for a CORESETPoolIndex. FIG. 2B illustrates a MAC-CE 220 for the activation of DL or UL TCI states for a CORESETPoolIndex.

The new MAC-CE is identified by a medium access control (MAC) subheader with a dedicated logical channel identifier (ID) (LCID). It has a variable size consisting the following fields:
A serving cell ID field 222, a DL bandwidth part (BWP) ID field 224, and a UL BWP ID field 226, respectively indicating the identity of the serving cell, the DL BWP, and the UL BWP for which the MAC-CE applies;
A CORESETPoolIndex field 228 that indicates the value of CORESETPoolIndex;
Pi fields 230 that indicate whether each TCI codepoint has multiple TCI States or single TCI States;
D/U fields 232 that each indicate whether the TCI State ID in the same octet is for a downlink or an uplink TCI State of the TCI State list with the indicated TRP ID; and
TCI state ID fields 234 that indicate the TCI state index provided by radio resource control (RRC) signaling for the corresponding TCI State list associated with the indicated TRP ID.

Alternatively, a CORESETPoolIndex value may be implicitly determined based on the control resource set (CORESET) where the MAC-CE physical downlink shared channel (PDSCH) is detected. With this design, the CORESETPoolIndex is not needed to be carried in a MAC-CE context.

Then, according to certain aspects of this disclosure, a variety of approaches maybe considered for unified TCI State indication for an mDCI mTRP use case using DCI format.

In a first alternative, the existing TCI field in the DCI format 1_1/1_2 (with or without DL assignment) associated with one of CORESETPoolIndex values is used to indicate the joint/DL/UL TCI state(s) corresponding to the same CORESETPoolIndex value.

In a second alternative, existing TCI field in any DCI format 1_1/1_2 (with or without DL assignment) is used to indicate joint/DL/UL TCI states corresponding to both CORESETPoolIndex values.

Note that this second alternative assumes a tight coordination between two TRPs in an mDCI mTRP use case, such that the unified TCI State update is maintained by a single TRP based on the beam measurement report from UE for DL beams associated with two TRPs.

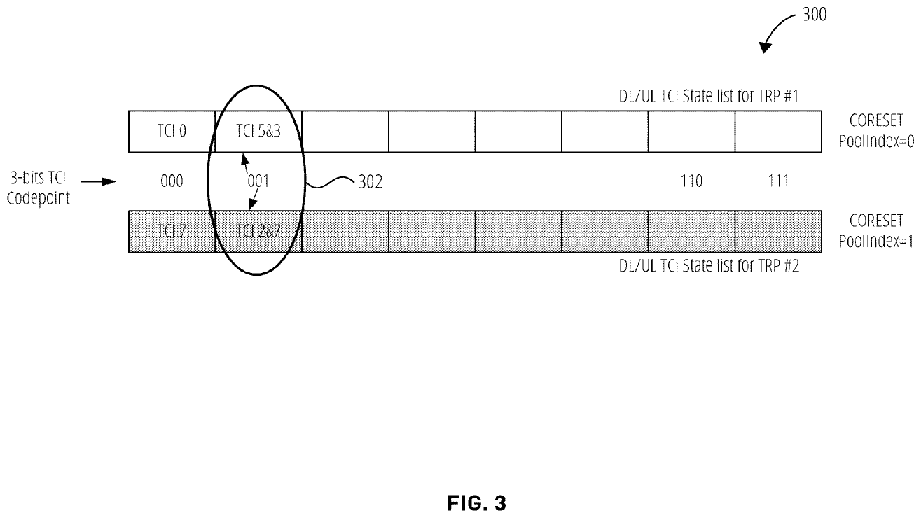

In a first option for the second alternative, a single 3-bit TCI field is used to indicate the unified TCI state pairs for two TRPs. FIG. 3 illustrates a diagram 300 showing the use of a single 3-bit TCI field to indicate the unified TCI state pairs for two TRPs. A gNB associates 302 two pairs of DL/UL unified TCI states, each pair for a TRP, with a single TCI codepoint in the DCI format.

This option is feasible assuming a gNB properly configures the TCI pair for two TRPs (e.g., based on the group-based beam reporting from a UE).

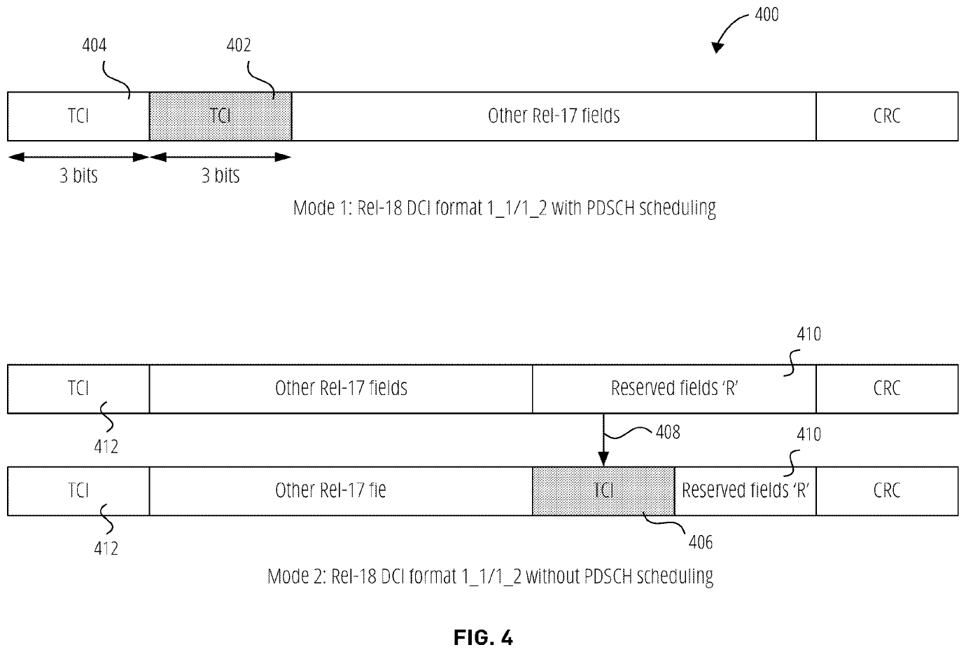

In a second option for the second alternative, two TCI fields may be included in the DCI format 1_1/1_2. FIG. 4 illustrates a diagram 400 showing uses of two TCI fields in DCI format 1_1/1_2.

In a first mode for this second option that uses data scheduling (denoted “Mode 1” in FIG. 4), an additional 3-bit TCI field 402 may be newly added to a Release-17 DCI format 1_1/1 2 with data scheduling. Then, the first 3-bit TCI field 404 is used to indicate the TCI codepoint associated with the TRP having TRP ID=0, and the additional 3-bit TCI field 402 is used to indicate the TCI codepoint associated with the TRP having TRP ID=1.

In a second mode for this second option that does not use data scheduling (denoted “Mode 2” in FIG. 4), an additional 3-bit TCI field 406 may be created by repurposing 408 the reserved field 410 of DCI 1_1/1_2 without data scheduling. Then, the first 3-bit TCI field 412 is used to indicate the TCI codepoint associated with the TRP having TRP ID=0, and the additional 3-bit TCI field 406 is used to indicate the TCI codepoint associated with the TRP having TRP ID=1.

Under this second option (e.g., under either of the first mode or the second mode of this second option), two pairs of <DL TCI State, UL TCI State> can be provided in a single DCI format, where the first pair of <DL TCI State, UL TCI State> is applied for the first TRP and second pair is applied for the second TRP.

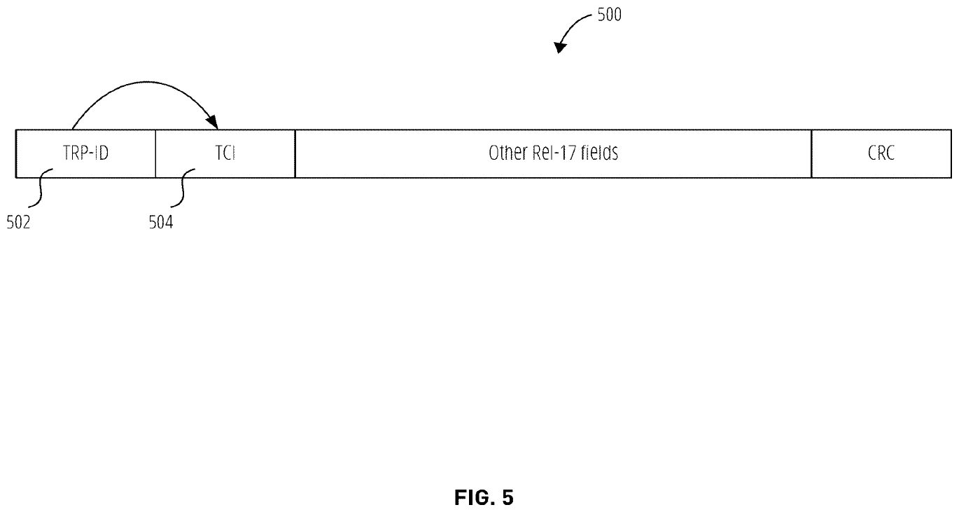

In a third option for the second alternative, a new field maybe introduced to indicate the TRP ID for which the TCI field information in the same DCI format is applied. FIG. 5 illustrates a DCI format 500 showing a TRP-ID field 502 of a DCI format that indicates a TRP ID for which the TCI field 504 information is applied. The TRP-ID field 502 may be any ID that can identify the TRP corresponding to the use of the TCI field 504 information.

In a fourth option for the second alternative, a two-step signaling approach may be used. In a first step, a UE may be configured with M DL TCI State pairs to associate with different TCI codepoint values by MAC-CE signaling, where at least one DL TCI State pair consists of one TCI State for TRP #1 and another TCI state for TRP #2. Then, in a second step, the 3-bit TCI field in a DCI format is used to select one from the M DL TCI States pairs (e.g., where M≤8) for one or both TRPs.

According to certain aspects of this disclosure, a UE applies the indicated unified joint/DL TCI State corresponding to a CORESETPoolIndex value for physical downlink control channel (PDCCH) reception(s) for a CORESET and associated search space sets if the CORESET or search space is explicitly configured to follow a unified TCI State. Otherwise, a separate TCI State maybe activated for a given CORESET by a MAC-CE that is different than the indicated unified TCI State.

According to certain aspects of this disclosure, a variety of approaches maybe considered to determine the TCI State(s) for PDSCH reception within a default QCL window for mDCI mTRP use cases. Herein, a window with duration of timeDurationForQCL starting from the symbol of DL DCI is termed as a “default QCL window.”

In a first alternative, a UE applies the DL TCI State of the CORESET with a monitored search space in a latest slot with a lowest ID with the same value of CORESETPoolIndex or the TCI State of the search space set with the same value of CORESETPoolIndex. In some designs, this first alternative maybe applied when the indicated TCI States are both associated with physical cell identifiers (IDs) (PCIs) different from the serving cells (in an inter-cell mTRP use case).

In a second alternative, a UE applies the unified DL TCI State of the CORESET with the same value of CORESETPoolIndex or the unified TCI State of the search space set with the same value of CORESETPoolIndex.

In each of the first alternative and the second alternative, the UE applies the indicated unified joint/DL TCI State corresponding to the CORESETPoolIndex value for PDSCH reception outside of the default QCL window.

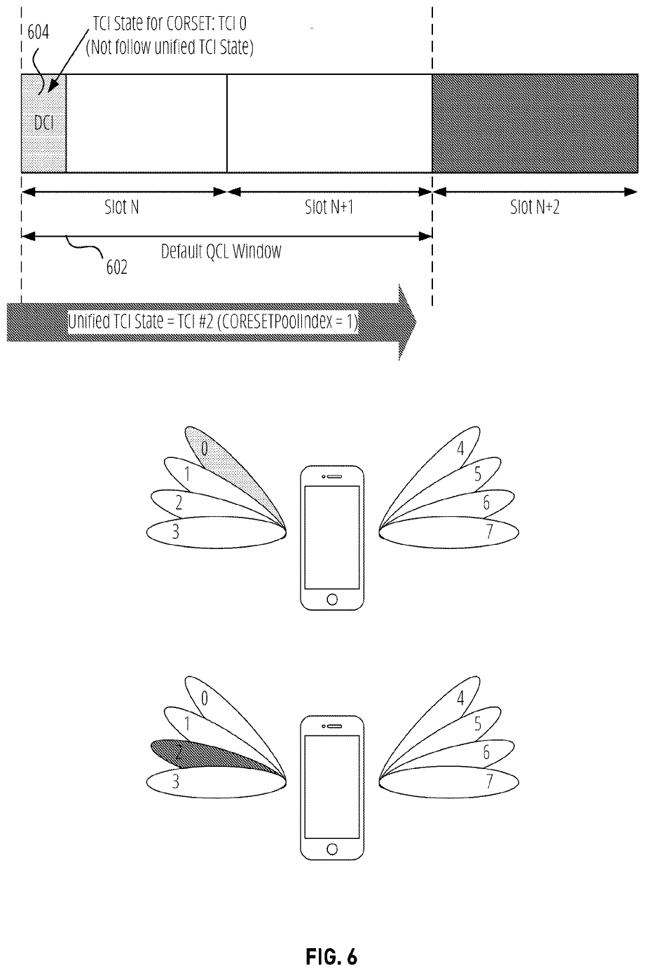

FIG. 6 provides examples in accordance with two alternatives for PDSCH reception within a default QCL window 602. It is assumed that DCI format 604 is detected in a PDCCH monitoring occasion associated with a CORESET that is configured to not follow a unified TCI State. TCI State #0 is configured for the search space of DCI format 604 or the CORESET of the DCI format 604.

In addition, it is assumed the unified TCI State #2 is indicated for CORESETPoolIndex=1 corresponding to TRP #1.

Under the first alternative, the UE assumes the TCI State of CORESET in the most recent slot for monitoring (TCI State #0) is applied for PDSCH reception in the default QCL window 602.

Under the second alternative, the UE assumes the unified TCI State of CORESETPoolIndex=1 is applied during the default QCL window 602.

According to certain aspects of this disclosure, the unified TCI State for the same value of CORESETPoolIndex maybe additionally applied for a set of DL/UL channels in mDCI mTRP use cases as follows:
an aperiodic channel state information reference signal (CSI-RS) resource set that is triggered by the DCI associated with the same value of CORESETPoolIndex value;
a physical uplink shared channel (PUSCH) that is scheduled by the DCI associated with the same value of CORESETPoolIndex value;
a configured grant physical uplink shared channel (CG-PUSCH) that is activated by the DCI associated with the same value of CORESETPoolIndex value;
a physical uplink control channel (PUCCH) that carries hybrid automatic repeat request acknowledgement (HARQ-ACK) bits corresponding to DCI associated with the same value of CORESETPoolIndex value;
a semi-persistent sounding reference signal (SRS) (SP-SRS) resource set that is activated by the DCI associated with the same value of CORESETPoolIndex value; and
an aperiodic SRS (A-SRS) resource set that is triggered by the DCI associated with the same value of CORESETPoolIndex value

For other signals/channels that are not explicitly associated with a CORESETPoolIndex value, multiple options may be available. In a first option, an indictor information element (IE) maybe introduced as part of RRC configuration to associate a signal/channel with a CORESETPoolIndex value. In a second option, a CORESETPoolIndex value for a TRP index may be directly provided for the signal/channel for the purpose of determining a unified TCI State.

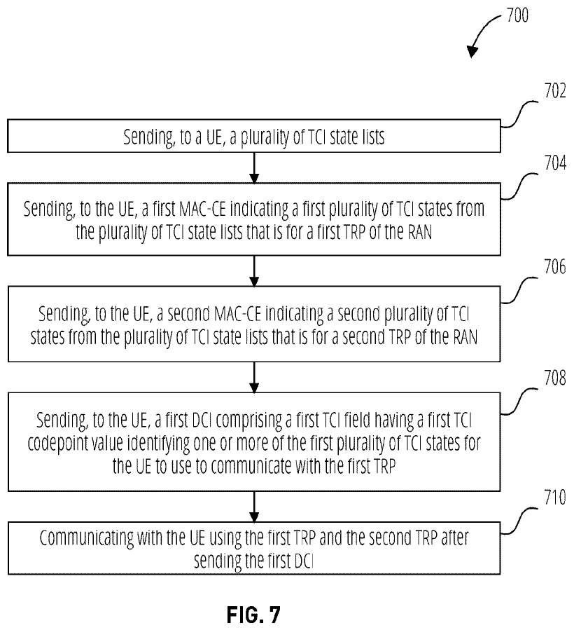

FIG. 7 illustrates a method 700 of a RAN, according to embodiments herein. The method 700 includes sending 702, to a UE, a plurality of TCI state lists.

The method 700 further includes sending 704, to the UE, a first MAC-CE indicating a first plurality of TCI states from the plurality of TCI state lists that is for a first TRP of the RAN.

The method 700 further includes sending 706, to the UE, a second MAC-CE indicating a second plurality of TCI states from the plurality of TCI state lists that is for a second TRP of the RAN.

The method 700 further includes sending 708, to the UE, a first DCI comprising a first TCI field having a first TCI codepoint value identifying one or more of the first plurality of TCI states for the UE to use to communicate with the first TRP.

The method 700 further includes communicating 710 with the UE using the first TRP and the second TRP after sending the first DCI.

In some embodiments of the method 700, the first TRP is associated with a first CORESET pool corresponding to a first CORESET pool index value, and the first MAC-CE includes a first CORESET pool index field that indicates the first CORESET pool index value.

In some embodiments of the method 700, the first TRP is associated with a first CORESET pool corresponding to a first CORESET pool index value, and the first MAC-CE is sent with a PDSCH scheduled by a PDCCH sent in a CORESET of the first CORESET pool.

In some embodiments of the method 700, the first MAC-CE comprises a bit field corresponding to the first TCI field having a value that identifies a number of the first plurality of TCI states that is associated with the first TCI codepoint of the first TCI field.

In some embodiments, the method 700 further includes sending, to the UE, a second DCI comprising a second TCI field having a second TCI codepoint value identifying one or more of the second plurality of TCI states for the UE to use to communicate with the second TRP, wherein the communicating with the UE using the first TRP and the second TRP occurs after sending the second DCI.

In some embodiments of the method 700, the first TCI codepoint value further identifies one or more of the second plurality of TCI states for the UE to use to communicate with the second TRP.

In some embodiments of the method 700, the first DCI further comprises a second TCI field having a second TCI codepoint value identifying one or more of the second plurality of TCI states for the UE to use to communicate with the second TRP.

In some embodiments of the method 700, the first DCI further comprises a bit field having a value identifying that the first TCI codepoint value is associated with the first TRP.

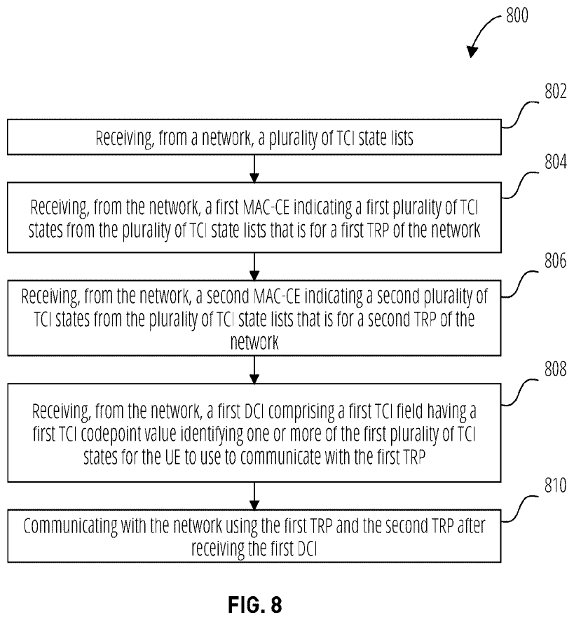

FIG. 8 illustrates a method 800 of a UE, according to embodiments herein. The method 800 includes receiving 802, from a network, a plurality of TCI state lists.

The method 800 further includes receiving 804, from the network, a first MAC-CE indicating a first plurality of TCI states from the plurality of TCI state lists that is for a first TRP of the network.

The method 800 further includes receiving 806, from the network, a second MAC-CE indicating a second plurality of TCI states from the plurality of TCI state lists that is for a second TRP of the network.

The method 800 further includes receiving 808, from the network, a first DCI comprising a first TCI field having a first TCI codepoint value identifying one or more of the first plurality of TCI states for the UE to use to communicate with the first TRP.

The method 800 further includes communicating 810 with the network using the first TRP and the second TRP after receiving the first DCI.

In some embodiments of the method 800, the first TRP is associated with a first CORESET pool corresponding to a first CORESET pool index value, the first MAC-CE includes a first CORESET pool index field that indicates the first CORESET pool index value, and the method 800 further includes identifying that the first MAC-CE is for the first TRP based on the indication of the first CORESET pool index value in the first CORESET pool index field of the first MAC-CE.

In some embodiments of the method 800, the first TRP is associated with a first CORESET pool corresponding to a first CORESET pool index value, the first MAC-CE is received with a PDSCH scheduled by a PDCCH received in a CORESET of the first CORESET pool, and the method 800 further includes identifying that the first MAC-CE is for the first TRP based on the reception of the PDCCH in the CORESET of the first CORESET pool.

In some embodiments of the method 800, the first MAC-CE comprises a bit field corresponding to the first TCI field having a value that identifies a number of the first plurality of TCI states that is associated with the first TCI codepoint of the first TCI field.

In some embodiments, the method 800 further includes receiving, from the network, a second DCI comprising a second TCI field having a second TCI codepoint value identifying one or more of the second plurality of TCI states for the UE to use to communicate with the second TRP, wherein the communicating with the network using the first TRP and the second TRP occurs after receiving the second DCI.

In some embodiments of the method 800, the first TCI codepoint value further identifies one or more of the second plurality of TCI states for the UE to use to communicate with the second TRP.

In some embodiments of the method 800, the first DCI further comprises a second TCI field having a second TCI codepoint value identifying one or more of the second plurality of TCI states for the UE to use to communicate with the second TRP.

In some embodiments of the method 800, the first DCI further comprises a bit field having a value identifying that the first TCI codepoint is associated with the first TRP.

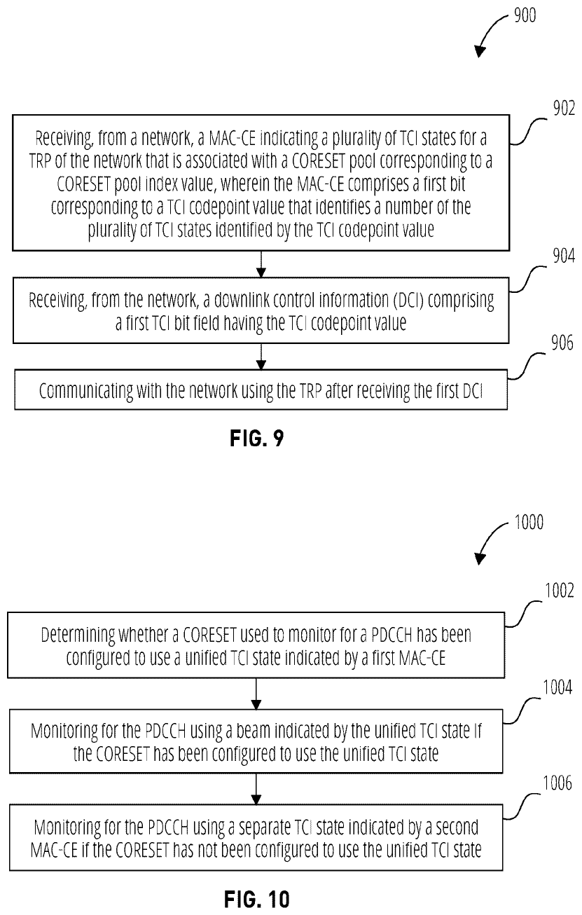

FIG. 9 illustrates a method 900 of a UE, according to embodiments herein. The method 900 includes receiving 902, from a network, a MAC-CE indicating a plurality of TCI states for a TRP of the network that is associated with a CORESET pool corresponding to a CORESET pool index value, wherein the MAC-CE comprises a first bit corresponding to a TCI codepoint value that identifies a number of the plurality of TCI states identified by the TCI codepoint value.

The method 900 further includes receiving 904, from the network, a DCI comprising a first TCI bit field having the TCI codepoint value.

The methods 900 further includes communicating 906 with the network using the TRP after receiving the first DCI.

In some embodiments of the method 900, the MAC-CE indicates the CORESET pool index value and the method 900 further includes identifying that the MAC-CE is for the TRP based on the indication of the CORESET pool index value in the MAC-CE.

In some embodiments of the method 900, the MAC-CE is received with a PDSCH scheduled by a PDCCH received in a CORESET of the CORESET pool and the method 900 further includes identifying that the MAC-CE is for the TRP based on the reception of the PDCCH in the CORESET of the CORESET pool.

In some embodiments of the method 900, the MAC-CE further comprises a second bit corresponding to a TCI state of the plurality of TCI states that identifies whether the TCI state is used for UL or DL.

FIG. 10 illustrates a method 1000 of a UE, according to embodiments herein. The method 1000 includes determining 1002 whether a CORESET used to monitor for a PDCCH has been configured to use a unified TCI state indicated by a first MAC-CE.

The method 1000 further includes monitoring 1004 for the PDCCH using a beam indicated by the unified TCI state if the CORESET has been configured to use the unified TCI state.

The method 1000 further includes monitoring 1006 for the PDCCH using a separate TCI state indicated by a second MAC-CE if the CORESET has not been configured to use the unified TCI state.

In some embodiments of the method 1000, the UE determines whether the CORESET is configured to use the unified TCI state by identifying whether the first MAC-CE indicates a CORSET pool index value of a CORESET pool that includes the CORESET.

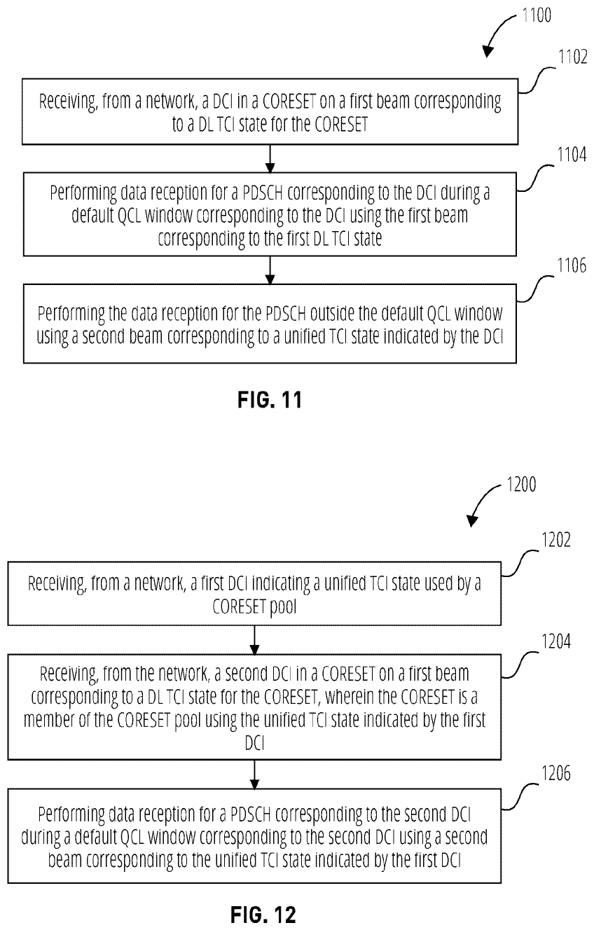

FIG. 11 illustrates a method 1100 of a UE, according to embodiments herein. The method 1100 includes receiving 1102, from a network, a DCI in a CORESET on a first beam corresponding to a DL TCI state for the CORESET.

The method 1100 further includes performing 1104 data reception for a PDSCH corresponding to the DCI during a default QCL window corresponding to the DCI using the first beam corresponding to the first DL TCI state.

The method 1100 further includes performing 1106 the data reception for the PDSCH outside the default QCL window using a second beam corresponding to a unified TCI state indicated by the DCI.

In some embodiments of the method 1100, the DCI triggers a transmission of a CSI-RS resource set and the method 1100 further includes sending, to the network, the CSI-RS resource set on the second beam corresponding to the unified TCI state indicated by the DCI.

In some embodiments of the method 1100, the DCI schedules a PUSCH and the method 1100 further includes sending, to the network, the PUSCH on the second beam corresponding to the unified TCI state indicated by the DCI.

In some embodiments of the method 1100, the DCI activates a CG-PUSCH and the method 1100 further includes sending, to the network, the CG-PUSCH on the second beam corresponding to the unified TCI state indicated by the DCI.

In some embodiments, the method 1100 further includes sending, to the network, a PUCCH comprising one or more HARQ-ACK bits corresponding to the DCI on the second beam corresponding to the unified TCI state indicated by the DCI.

In some embodiments of the method 1100, the DCI activates an SP-SRS resource set and the method 1100 further includes sending, to the network, the SP-SRS resource set on the second beam corresponding to the unified TCI state indicated by the DCI.

In some embodiments of the method 1100, the DCI activates an A-SRS resource set and the method 1100 further includes sending, to the network, the A-SRS resource set on the second beam corresponding to the unified TCI state indicated by the DCI.

In some embodiments, the method 1100 further includes receiving, from the network, an IE indicating that a signal type is associated with the CORESET pool using the unified TCI state, wherein the DCI triggers a use of the signal type, and communicating with the network using the signal type using the second beam corresponding to the unified TCI state indicated by the DCI.

In some embodiments, the method 1100 further includes receiving, from the network, an indication that associates a signal type on a TRP of the network to the CORESET pool using the unified TCI state, the indication comprising a CORESET pool index value for the CORESET pool using the unified TCI state, wherein the DCI triggers a use of the signal type with the TRP, and communicating with the TRP using the signal type using the second beam corresponding to the unified TCI state indicated by the DCI.

FIG. 12 illustrates a method 1200 of a UE, according to embodiments herein. The method 1200 includes receiving 1202, from a network, a first DCI indicating a unified TCI state used by a CORESET pool.

The method 1200 further includes receiving 1202, from the network, a second DCI in a CORESET on a first beam corresponding to a DL TCI state for the CORESET, wherein the CORESET is a member of the CORESET pool using the unified TCI state indicated by the first DCI.

The method 1200 further includes performing 1206 data reception for a PDSCH corresponding to the second DCI during a default QCL window corresponding to the second DCI using a second beam corresponding to the unified TCI state indicated by the first DCI.

In some embodiments of the method 1200, the second DCI triggers a transmission of a CSI-RS resource set, and the method 1200 further includes sending, to the network, the CSI-RS resource set on the second beam corresponding to the unified TCI state indicated by the first DCI.

In some embodiments of the method 1200, the second DCI schedules a PUSCH and the method 1200 further includes sending, to the network, the PUSCH on the second beam corresponding to the unified TCI state indicated by the first DCI.

In some embodiments of the method 1200, the second DCI activates a CG-PUSCH and the method 1200 further includes sending, to the network, the CG-PUSCH on the second beam corresponding to the unified TCI state indicated by the first DCI.

In some embodiments, the method 1200 further includes sending, to the network, a PUCCH comprising one or more HARQ-ACK bits corresponding to the second DCI on the second beam corresponding to the unified TCI state indicated by the first DCI.

In some embodiments, the method 1200 further includes sending, to the network, a PUCCH comprising one or more HARQ-ACK bits corresponding to the second DCI on the second beam corresponding to the unified TCI state indicated by the first DCI.

In some embodiments of the method 1200, the second DCI activates an A-SRS resource set and the method 1200 further includes sending, to the network, the A-SRS resource set on the second beam corresponding to the unified TCI state indicated by the first DCI.

In some embodiments, the method 1200 further includes receiving, from the network, an IE indicating that a signal type is associated with the CORESET pool using the unified TCI state, wherein the second DCI triggers a use of the signal type, and communicating with the network using the signal type using the second beam corresponding to the unified TCI state indicated by the first DCI.

In some embodiments, the method 1200 further includes receiving, from the network, an indication that associates a signal type on a TRP of the network to the CORESET pool using the unified TCI state, the indication comprising a CORESET pool index value for the CORESET pool using the unified TCI state, wherein the second DCI triggers a use of the signal type with the TRP, and communicating with the TRP using the signal type using the second beam corresponding to the unified TCI state indicated by the first DCI.

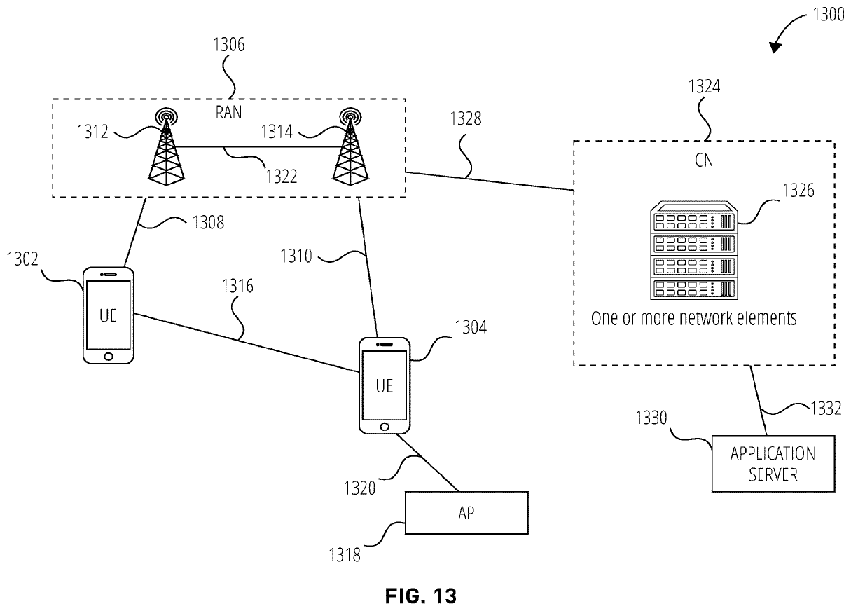

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations (such as base station 1312 and base station 1314) that enable the connection 1308 and connection 1310.

In this example, the connection 1308 and connection 1310 are air interfaces to enable such communicative coupling, and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VoIP sessions, group communication sessions, etc.) for the UE 1302 and UE 1304 via the CN 1324. The application server 1330 may communicate with the CN 1324 through an IP communications interface 1332.

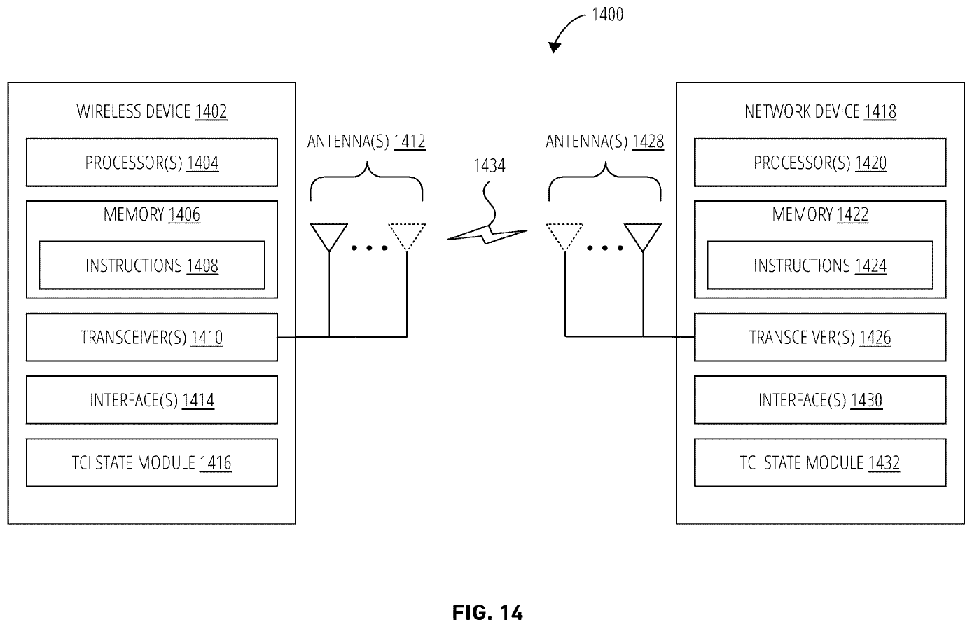

FIG. 14 illustrates a system 1400 for performing signaling 1434 between a wireless device 1402 and a network device 1418, according to embodiments disclosed herein. The system 1400 may be a portion of a wireless communications system as herein described. The wireless device 1402 may be, for example, a UE of a wireless communication system. The network device 1418 may be, for example, a base station (e.g., an eNB or a gNB) of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter and/or receiver circuitry that use the antenna(s) 1412 of the wireless device 1402 to facilitate signaling (e.g., the signaling 1434) to and/or from the wireless device 1402 with other devices (e.g., the network device 1418) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include a TCI state module 1416. The TCI state module 1416 may be implemented via hardware, software, or combinations thereof. For example, the TCI state module 1416 may be implemented as a processor, circuit, and/or instructions 1408 stored in the memory 1406 and executed by the processor(s) 1404. In some examples, the TCI state module 1416 may be integrated within the processor(s) 1404 and/or the transceiver(s) 1410. For example, the TCI state module 1416 may be implemented by a combination of software components (e.g., executed by a DSP or a general processor) and hardware components (e.g., logic gates and circuitry) within the processor(s) 1404 or the transceiver(s) 1410.

The TCI state module 1416 may be used for various aspects of the present disclosure, for example, aspects of FIG. 1 through FIG. 12. The TCI state module 1416 is configured to, for example, use TCI state indications for mDCI mTRP use cases in the manner(s) described herein.

The network device 1418 may include one or more processor(s) 1420. The processor(s) 1420 may execute instructions such that various operations of the network device 1418 are performed, as described herein. The processor(s) 1420 may include one or more baseband processors implemented using, for example, a CPU, a DSP, an ASIC, a controller, an FPGA device, another hardware device, a firmware device, or any combination thereof configured to perform the operations described herein.

The network device 1418 may include a memory 1422. The memory 1422 may be a non-transitory computer-readable storage medium that stores instructions 1424 (which may include, for example, the instructions being executed by the processor(s) 1420). The instructions 1424 may also be referred to as program code or a computer program. The memory 1422 may also store data used by, and results computed by, the processor(s) 1420.

The network device 1418 may include one or more transceiver(s) 1426 that may include RF transmitter and/or receiver circuitry that use the antenna(s) 1428 of the network device 1418 to facilitate signaling (e.g., the signaling 1434) to and/or from the network device 1418 with other devices (e.g., the wireless device 1402) according to corresponding RATs.

The network device 1418 may include one or more antenna(s) 1428 (e.g., one, two, four, or more). In embodiments having multiple antenna(s) 1428, the network device 1418 may perform MIMO, digital beamforming, analog beamforming, beam steering, etc., as has been described.

The network device 1418 may include one or more interface(s) 1430. The interface(s) 1430 may be used to provide input to or output from the network device 1418. For example, a network device 1418 that is a base station may include interface(s) 1430 made up of transmitters, receivers, and other circuitry (e.g., other than the transceiver(s) 1426/antenna(s) 1428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1418 may include a TCI state module 1432. The TCI state module 1432 may be implemented via hardware, software, or combinations thereof. For example, the TCI state module 1432 may be implemented as a processor, circuit, and/or instructions 1424 stored in the memory 1422 and executed by the processor(s) 1420. In some examples, the TCI state module 1432 may be integrated within the processor(s) 1420 and/or the transceiver(s) 1426. For example, the TCI state module 1432 may be implemented by a combination of software components (e.g., executed by a DSP or a general processor) and hardware components (e.g., logic gates and circuitry) within the processor(s) 1420 or the transceiver(s) 1426.

The TCI state module 1432 may be used for various aspects of the present disclosure, for example, aspects of FIG. 1 through FIG. 12. The TCI state module 1432 is configured to, for example, make TCI state indications for mDCI mTRP use cases in the manner(s) described herein.

Embodiments contemplated herein include an apparatus comprising means to perform one or more elements of one or more of the method 800, the method 900, the method 1000, the method 1100, and/or the method 1200. This apparatus may be, for example, an apparatus of a UE (such as a wireless device 1402 that is a UE, as described herein).

Embodiments contemplated herein include one or more non-transitory computer-readable media comprising instructions to cause an electronic device, upon execution of the instructions by one or more processors of the electronic device, to perform one or more elements of one or more of the method 800, the method 900, the method 1000, the method 1100, and/or the method 1200. This non-transitory computer-readable media may be, for example, a memory of a UE (such as a memory 1406 of a wireless device 1402 that is a UE, as described herein).

Embodiments contemplated herein include an apparatus comprising logic, modules, or circuitry to perform one or more elements of one or more of the method 800, the method 900, the method 1000, the method 1100, and/or the method 1200. This apparatus may be, for example, an apparatus of a UE (such as a wireless device 1402 that is a UE, as described herein).

Embodiments contemplated herein include an apparatus comprising: one or more processors and one or more computer-readable media comprising instructions that, when executed by the one or more processors, cause the one or more processors to perform one or more elements of one or more of the method 800, the method 900, the method 1000, the method 1100, and/or the method 1200. This apparatus may be, for example, an apparatus of a UE (such as a wireless device 1402 that is a UE, as described herein).

Embodiments contemplated herein include a signal as described in or related to one or more elements of one or more of the method 800, the method 900, the method 1000, the method 1100, and/or the method 1200.

Embodiments contemplated herein include a computer program or computer program product comprising instructions, wherein execution of the program by a processor is to cause the processor to carry out one or more elements of one or more of the method 800, the method 900, the method 1000, the method 1100, and/or the method 1200. The processor may be a processor of a UE (such as a processor(s) 1404 of a wireless device 1402 that is a UE, as described herein). These instructions may be, for example, located in the processor and/or on a memory of the UE (such as a memory 1406 of a wireless device 1402 that is a UE, as described herein).

Embodiments contemplated herein include an apparatus comprising means to perform one or more elements of the method 700. This apparatus may be, for example, an apparatus of a base station (such as a network device 1418 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 1422 of a network device 1418 that is a base station, as described herein).

Embodiments contemplated herein include an apparatus comprising logic, modules, or circuitry to perform one or more elements of the method 700. This apparatus may be, for example, an apparatus of a base station (such as a network device 1418 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 1418 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 1420 of a network device 1418 that is a base station, as described herein). These instructions may be, for example, located in the processor and/or on a memory of the base station (such as a memory 1422 of a network device 1418 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
determining whether a control resource set (CORESET) used to monitor for a physical downlink control channel (PDCCH) has been configured to use a unified transmission configuration indicator (TCI) state indicated by a first medium access control control element (MAC-CE);
monitoring for the PDCCH using a beam indicated by the unified TCI state if the CORESET has been configured to use the unified TCI state; and
monitoring for the PDCCH using a separate TCI state indicated by a second MAC-CE if the CORESET has not been configured to use the unified TCI state.

2. The method of claim 1, wherein the UE determines whether the CORESET is configured to use the unified TCI state by identifying whether the first MAC-CE indicates a CORSET pool index value of a CORESET pool that includes the CORESET.

3. A method of a user equipment (UE), comprising:
receiving, from a network, a downlink control information (DCI) in a control resource set (CORESET) on a first beam corresponding to a downlink (DL) transmission configuration indicator (TCI) state for the CORESET;
performing data reception for a physical downlink shared channel (PDSCH) corresponding to the DCI during a default quasi-colocation (QCL) window corresponding to the DCI using the first beam corresponding to the first DL TCI state; and
performing the data reception for the PDSCH outside the default QCL window using a second beam corresponding to a unified TCI state indicated by the DCI.

4. The method of claim 3, wherein the DCI triggers a transmission of a channel state information reference signal (CSI-RS) resource set, and further comprising sending, to the network, the CSI-RS resource set on the second beam corresponding to the unified TCI state indicated by the DCI.

5. The method of claim 3, wherein the DCI schedules a physical uplink shared channel (PUSCH), and further comprising sending, to the network, the PUSCH on the second beam corresponding to the unified TCI state indicated by the DCI.

6. The method of claim 3, wherein the DCI activates a configured grant physical uplink shared channel (CG-PUSCH), and further comprising sending, to the network, the CG-PUSCH on the second beam corresponding to the unified TCI state indicated by the DCI.

7. The method of claim 3, further comprising sending, to the network, a physical uplink control channel (PUCCH) comprising one or more hybrid automatic repeat request acknowledgment (HARQ-ACK) bits corresponding to the DCI on the second beam corresponding to the unified TCI state indicated by the DCI.

8. The method of claim 3, wherein the DCI activates a semi-persistent sounding reference signal (SP-SRS) resource set, and further comprising sending, to the network, the SP-SRS resource set on the second beam corresponding to the unified TCI state indicated by the DCI.

9. The method of claim 3, wherein the DCI activates an aperiodic sounding reference signal (A-SRS) resource set, and further comprising sending, to the network, the A-SRS resource set on the second beam corresponding to the unified TCI state indicated by the DCI.

10. The method of claim 3,
further comprising receiving, from the network, an information element (IE) indicating that a signal type is associated with the CORESET pool using the unified TCI state;
wherein the DCI triggers a use of the signal type; and
further comprising communicating with the network using the signal type using the second beam corresponding to the unified TCI state indicated by the DCI.

11. The method of claim 3,
further comprising receiving, from the network, an indication that associates a signal type on a transmission reception point (TRP) of the network to the CORESET pool using the unified TCI state, the indication comprising a CORESET pool index value for the CORESET pool using the unified TCI state;
wherein the DCI triggers a use of the signal type with the TRP; and
further comprising communicating with the TRP using the signal type using the second beam corresponding to the unified TCI state indicated by the DCI.

12. A method of a user equipment (UE), comprising:
receiving, from a network, a first downlink control information (DCI) indicating a unified transmission configuration indicator (TCI) state used by a control resource set (CORESET) pool;
receiving, from the network, a second DCI in a CORESET on a first beam corresponding to a downlink (DL) TCI state for the CORESET, wherein the CORESET is a member of the CORESET pool using the unified TCI state indicated by the first DCI; and
performing data reception for a physical downlink shared channel (PDSCH) corresponding to the second DCI during a default quasi-colocation (QCL) window corresponding to the second DCI using a second beam corresponding to the unified TCI state indicated by the first DCI.

13. The method of claim 12, wherein the second DCI triggers a transmission of a channel state information reference signal (CSI-RS) resource set, and further comprising sending, to the network, the CSI-RS resource set on the second beam corresponding to the unified TCI state indicated by the first DCI.

14. The method of claim 12, wherein the second DCI schedules a physical uplink shared channel (PUSCH), and further comprising sending, to the network, the PUSCH on the second beam corresponding to the unified TCI state indicated by the first DCI.

15. The method of claim 12, wherein the second DCI activates a configured grant physical uplink shared channel (CG-PUSCH), and further comprising sending, to the network, the CG-PUSCH on the second beam corresponding to the unified TCI state indicated by the first DCI.

16. The method of claim 12, further comprising sending, to the network, a physical uplink control channel (PUCCH) comprising one or more hybrid automatic repeat request acknowledgment (HARQ-ACK) bits corresponding to the second DCI on the second beam corresponding to the unified TCI state indicated by the first DCI.

17. The method of claim 12, wherein the second DCI activates a semi-persistent sounding reference signal (SP-SRS) resource set, and further comprising sending, to the network, the SP-SRS resource set on the second beam corresponding to the unified TCI state indicated by the first DCI.

18. The method of claim 12, wherein the second DCI activates an aperiodic sounding reference signal (A-SRS) resource set, and further comprising sending, to the network, the A-SRS resource set on the second beam corresponding to the unified TCI state indicated by the first DCI.

19. The method of claim 12,
further comprising receiving, from the network, an information element (IE) indicating that a signal type is associated with the CORESET pool using the unified TCI state;
wherein the second DCI triggers a use of the signal type; and
further comprising communicating with the network using the signal type using the second beam corresponding to the unified TCI state indicated by the first DCI.

20. The method of claim 12, further comprising:
further receiving, from the network, an indication that associates a signal type on a transmission reception point (TRP) of the network to the CORESET pool using the unified TCI state, the indication comprising a CORESET pool index value for the CORESET pool using the unified TCI state;
wherein the second DCI triggers a use of the signal type with the TRP; and
further comprising communicating with the TRP using the signal type using the second beam corresponding to the unified TCI state indicated by the first DCI.

21-23. (canceled)
